(19) United States
(12) Patent Application Publication
(10) Pub. No.: US 2016/0143063 A1
(43) Pub. Date: May 19, 2016

(54) Enhanced RACH Design for Machine-Type Communications

(71) Applicants: MEDIATEK INC., Hsinchu (TW); National Taiwan University, Taipei City (TW)

(72) Inventors: Guan-Yu Lin, Nantou County (TW); Hung-Yu Wei, Taipei City (TW); Yih-Shen Chen, Hsinchu City (TW); Chia-Chun Hsu, Taipei City (TW)

(21) Appl. No.: 15/006,427

(22) Filed: Jan. 26, 2016

Related U.S. Application Data
(63) Continuation of application No. 13/136,558, filed on Aug. 3, 2011, now abandoned.
(60) Provisional application No. 61/370,555, filed on Aug. 4, 2010.

(51) Int. Cl. H04W 74/08; H04W 4/00

(52) U.S. Cl. CPC H04W 74/0833; H04W 4/005

(57) ABSTRACT

An adaptive RACH operation is proposed for machine-type communications (MTC) in a 3GPP wireless network. The adaptive RACH operation is based on context information to reduce RACH collision probability, to control network overload, and to enhance system performance. The context information includes device related information and network related information. Device related information includes device type and service or application type. Network related information includes network load information and historical statistics information. Based on the context information, an MTC device adjusts various network access and RACH parameters by applying adaptive RACH operation in different levels. For example, in the application level and the network level, the MTC device adjusts its access probability or RACH backoff time for RACH access. In the radio access network (RAN) level, the MTC device adjusts its access probability or RACH backoff time, or transmits RACH preambles using adjusted RACH radio resources and preambles.

### CRSS REFERENCE TO RELATED APPLICATIONS

This application is a continuation, and claims priority under 35 U.S.C. §120 from nonprovisional U.S. patent application Ser. No. 13/136,558, entitled “ENHANCED RACH DESIGN FOR MACHINE-TYPE COMMUNICATIONS,” filed on Aug. 3, 2011, the subject matter of which is incorporated herein by reference. Application Ser. No. 13/136,558, in turn, claims priority under 35 U.S.C. §119 from U.S. Provisional Application No. 61/370,555, entitled “Protocol Design to Reduce RACH Collision in Machine-Type Communications”, filed on Aug. 4, 2010; the subject matter of which is incorporated herein by reference.

### TECHNICAL FIELD

The disclosed embodiments relate generally to Machine type communications, and, more particularly, to enhanced RACH design for machine type communications.

### BACKGROUND

Machine type communication is a form of data communication that involves one or more entities that do not necessarily need human interaction. A service optimized for machine type communication differs from a service optimized for human-to-human (H2H) communication. Typically, machine type communication services are different to current mobile network communication services as it involves different market scenarios, pure data communication, lower cost and effort, and a potentially very large number of communicating terminals with little traffic per terminal.

The terms Machine-to-Machine (M2M) and Machine-Type Communications (MTC) are used to describe use cases and illustrate the diverse characteristics of machine type communication service. M2M and MTC devices will be part of the next generation wireless networks to enable “internet of things”. Potential M2M and MTC applications include security, tracking and tracing, payment, health, remote maintenance/control, metering, and consumer devices. The main characteristics of machine type communication services include low mobility, time controlled, delay tolerant, packet-switched only, small data transmissions, mobile originated only, infrequent mobile terminated, MTC monitoring, priority alarm, secure connection, location specific trigger, network provided destination for uplink data, infrequency transmission, and group based MTC features.

The end-to-end application between an MTC device and an MTC server or between two MTC devices is provided by 3GPP systems. A 3GPP system provides transport and communication services optimized for MTC. MTC traffic, however, may not be controlled by the network/core network. For example, an MTC application may request many MTC devices to do “something” at the same time, resulting in a large number of M2M devices trying to access the wireless service during a very short amount of time. As a result, many MTC devices may send a large number of random access channel (RACH) preambles and thereby causing high RACH collision probability. In addition, when a core network entity goes down, there is no mechanism to postpone the MTC devices from continuous access attempts. Consequently, many MTC devices are roamers and may all move to local competing networks when their own serving network fails, which may potentially cause traffic overload in the not (yet) failed network(s).

FIG. 1 (Prior Art) illustrates a radio network congestion use case in a 3GPP network 100. 3GPP network 100 comprises a MTC server 110, a packet data network gateway (PDN GW) 120, a serving GW 130, two base stations eNB 141 and eNB 142, and a plurality of M2M devices. Radio network congestion occurs when massive concurrent data transmission takes place in some MTC applications, as illustrated in FIG. 1. One of the typical applications is bridge monitoring with a mass of sensors. When a train passes through the bridge, all the MTC sensors transmit monitoring data almost simultaneously. The same thing happens in hydrology monitoring during the time of heavy rain, and in building monitoring when intruders break in. Therefore, it is desirable that the network is optimized to enable a mass of MTC devices in a particular area to transmit data almost simultaneously.

FIG. 2 (Prior Art) illustrates a core network congestion use case in a 3GPP network 200. 3GPP network 200 comprises a MTC server 210, a packet data network gateway (PDN GW) 220, a serving GW 230, two base stations eNB 241 and eNB 242, and a plurality of M2M devices. For many MTC applications, a large number of MTC devices are affiliated with a single MTC user (e.g., MTC user 250). These MTC devices together are part of a MTC group (e.g., MTC group 260). For example, MTC user 250 is associated with MTC group 260, and MTC user 250 owns MTC server 210. The MTC devices in MTC group 260 communicate with MTC server 210. Typically, the MTC devices in the same MTC group are scattered over the network in such a way that the data simultaneously sent by the MTC devices in any particular cell is limited and will not cause a radio network overload. However, when a high number of MTC devices are sending/receiving data simultaneously, data congestion may occur in the mobile core network or on the link between the mobile core network and the MTC server where the data traffic related to the MTC group is aggregated, as illustrated in FIG. 2. Therefore, it is desirable that a network operator and the MTC user have means to enforce a maximum rate for the data sent/received by the same MTC group.

According to current RACH procedure in 3GPP systems, the maximum RACH capacity is 64,000 random access attempts per second (e.g., 1 PRACH per subframe and 64 preambles for RA). To meet 1% RACH collision requirement, the maximum RACH access is thus approximately 643 per second. Although such maximum RACH access rate is considered high, it may not be sufficient to support mass amount of concurrent data transmission in some MTC applications. Moreover, allocating extra RACH resources may lead to inefficient radio resource usage. Enhanced RACH solutions are sought for optimized MTC services.

### SUMMARY

An adaptive RACH operation is proposed for machine-type communications (MTC) in a 3GPP wireless network. The adaptive RACH operation is based on context information to reduce RACH collision probability, to control network overload, and to enhance system performance. The context information includes device related information and network related information. Device related information includes device type and service or application type. Network related information includes network load information and historical statistics information. Based on the context information, an MTC device adjusts various network access and RACH parameters by applying adaptive RACH operation in different levels. For example, in the application level and the network level, the MTC device adjusts its access probability and/or RACH backoff time for RACH access. In the radio access network (RAN) level, the MTC device adjusts its access probability and/or RACH backoff time, and/or transmits RACH preambles using adjusted RACH radio resources and preambles.

In a first embodiment, the MTC device adjusts its access probability before RACH operation in different levels including APP, NAS, and/or RAN level. As compared to H2H Access Class (AC), M2M Access Class (AC) may apply different access probability, barring parameters, and retry timer parameters. In application level access distribution, barring is done by prioritize access based on type of services (e.g., based on QoS requirement and/or delay-tolerant level of different applications). In NAS level access distribution, barring is done by access restriction (e.g., prioritize access based on service type, MTC server, and device ID). In RAN level access distribution, barring is done by applying different barring factor for different AC classes.

In a second embodiment, the MTC device adjusts its backoff time during RACH operation in different levels including APP, NAS, and/or RAN level. The RACH backoff delay may be applied before transmitting the first RACH preamble as well as after a RACH preamble collision. The initial RACH access distribution before the first RACH prevents high-level RACH contention, thus is more likely to be implemented in application or network level. Once RACH collision is experienced, specific backoff times can then be applied during RACH procedure for each MTC device. Different backoff times may be applied for different delay-tolerant M2M scenarios.

In a third embodiment, the MTC device transmits RACH preamble(s) with adjusted RACH resources in RAN level. The network adaptively adjusts RACH resource allocation for resources used by M2M-only devices, H2H-only devices, and by both M2M and H2H devices. Based on application requirement and priority access class, devices choose to use either dedicated RACH resource or shared RACH resource. Moreover, the RACH resource allocation is further adjusted based on load information (e.g., M2M traffic load and/or H2H traffic load), RACH collision probability, and other context information.

In a fourth embodiment, RACH-less solution is applied to transmit MTC data for MTC devices with low or no mobility. Preconfigured UL resources are used to transmit MTC data because the requirement for MTC is in general fixed over time and across different MTC devices. MTC data is transmitted over the UL resources without RRC establishment to reduce RRC signaling overhead. In one example, an eNB transmits MTC configuration followed by one or multiple MTC grants to an MTC device via broadcasted or dedicated transmission. The MTC device transmits MTC data using the granted resource. The RACH-less solution does not require any contention-based access mechanism and is suitable for many MTC applications.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (Prior Art) illustrates a radio network congestion use case in a 3GPP network.

FIG. 2 (Prior Art) illustrates a core network congestion use case in a 3GPP network.

FIG. 3 illustrates a 3GPP network that supports Machine-Type Communication (MTC) in accordance with one novel aspect.

FIG. 4 illustrates adaptive random access channel (RACH) operation in accordance with one novel aspect.

FIG. 5 illustrates a first option of adaptive RACH operation by adjusting access probability.

FIG. 6 illustrates a second option of adaptive RACH operation by adjusting RACH backoff time.

FIG. 7 illustrates a third option of adaptive RACH operation by adjusting RACH resource allocation.

FIG. 8 illustrates a method of RACH-less solution for optimizing machine-type communications.

FIG. 9 is a flow chart of a method of adaptive RACH operation for optimized machine-type communication in accordance with one novel aspect.

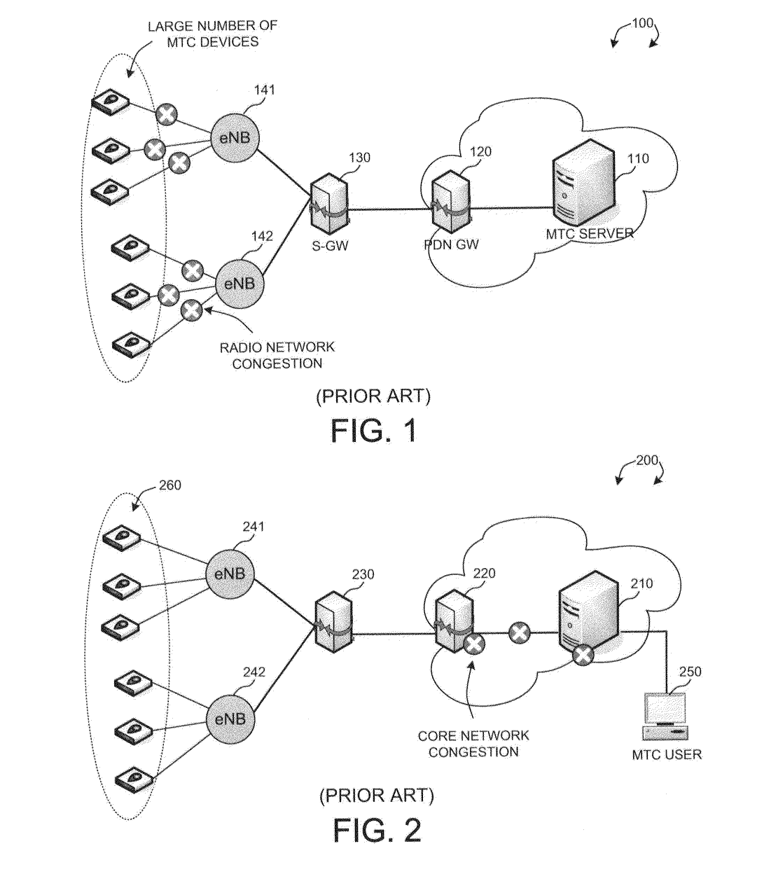

### DETAILED DESCRIPTION

Reference will now be made in detail to some embodiments of the invention, examples of which are illustrated in the accompanying drawings.

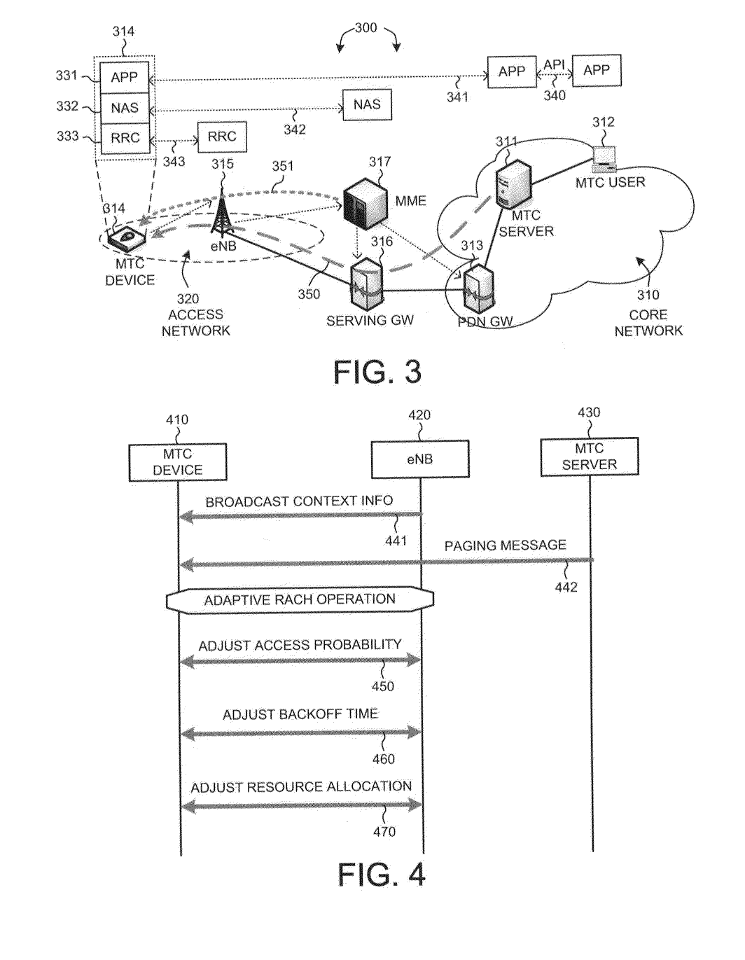

FIG. 3 illustrates a 3GPP network 300 that supports Machine-Type Communications (MTC) in accordance with one novel aspect. 3GPP network 300 comprises an MTC server 311 that provides various MTC services to an MTC user 312 by communicating with a plurality of MTC devices (e.g., MTC device 314 as illustrated in FIG. 3). In the example of FIG. 3, MTC server 311, MTC user 312, and a packet data network gateway (PDN GW) 313 belong to part of a core network 310. MTC device 314 and its serving base station (eNB) 315 belong to part of a radio access network (RAN) 320. MTC server 311 communicates with MTC device 314 through PDN GW 313, serving GW 316, and eNB 315. In addition, a mobility management entity (MME) 317 communicates with eNB 315, serving GW 316 and PDN GW 313 for mobility management of wireless access devices in 3GPP network 300. It is noted that, the term MTC is also referred to as machine-to-machine (M2M) communication as compared to human-to-human (H2H) communication, while an MTC device is also referred to as an M2M device as compared to H2H device.

In the example of FIG. 3, MTC server 311 provides various MTC services/applications to MTC user 312 in application (APP) protocol layer through an established application-programming interface (API) 340. Typical MTC applications include security (e.g., surveillance system), tracking and tracing (e.g., pay as you drive), payment (e.g., vending and gaming machines), health (e.g., health persuasion system), remote maintenance/control, metering (e.g., smart grid), and consumer devices (e.g., eBooks). To provide the end-to-end MTC services, MTC server 311 communicates with the plurality of MTC devices in the 3GPP network. Each MTC device (e.g. MTC device 314) comprises various protocol layer modules to support the end-to-end MTC applications and data connections. In the application level, APP module 331 communicates with MTC server 311 in APP protocol layer (e.g., depicted by dashed line 341), which provides the end-to-end control/data. In the network level, NAS module 332 communicates with MME 317 in non-access stratum protocol layer (e.g., depicted by dashed line 342), which supports mobility management and other signaling functionality. In the radio network access (RAN) level, RRC module 333 communicates with eNB 315 in radio resource control (RRC) protocol layer (e.g., depicted by dashed line 343), which takes care of broadcast of system information, RRC connection control, paging, radio configuration control, QoS control, etc.

In 3GPP systems, a random access channel (RACH) is used in mobile phones or other wireless access terminals such as MTC or M2M devices for contention-based uplink transmission. RACH is a shared uplink channel that is used by wireless access terminals to request access and acquire ownership of an uplink channel to initiate transmission with their serving base stations via a RACH procedure. Because the MTC server is not necessarily located inside the network operator domain, and because end-to-end MTC services may not necessarily involve the MTC server, MTC traffic is most likely not controlled by the network/core network. As a result, if a large number of MTC devices (e.g., much larger than the designed dimension, in terms of the number of UEs of a cell, or an eNB, or an MME) want to access wireless service during a short amount of time, a large number of RACH preambles sent from the MTC devices to their serving base station would likely to cause high RACH collision probability. Furthermore, when a core network went down, many MTC devices are roamers and all move to local competing networks when their own serving network fails, which would potentially overload the not (yet) failed network(s).

In one novel aspect, a traditional RACH procedure is adapted based on context information to reduce RACH collision probability, to control network overload, and to enhance system performance. The context information includes device related information and network related information. Device related information includes device type (e.g., M2M device or H2H device) and service or application type (e.g., security, tracking and tracing, payment, health, remote maintenance/control, metering, and consumer devices). Network related information includes load information and historical statistics information. Based on the obtained context information (e.g., forwarded from MTC server 311 to MTC device 314 as depicted by a thick dashed line 350, or from MME 317 to MTC device 314 as depicted by a thick dotted line 351), MTC device 314 can adjust various network access and RACH parameters by applying adaptive RACH operation in different layers. For example, in the APP layer and the NAS layer, MTC device 314 adjusts its access probability or RACH backoff time for adaptive RACH operation. On the other hand, in the RRC layer, MTC device 314 adjusts its access probability or RACH backoff time, or transmits RACH preambles using adjusted RACH resources for adaptive RACH operation. Context information like overload indication (congested network entity, e.g. APN, or MTC server, etc.) can be sent from MME 317 to eNB 315. Based on the information, eNB 315 decides whether to respond to certain connection request from MTC device 314.

FIG. 4 illustrates adaptive random access channel (RACH) operation in accordance with one novel aspect. In the example of FIG. 4, MTC device 410 communicates with MTC server 430 via eNB 420. Before starting RACH, MTC device 410 first obtains context information for adaptive RACH operation. The context information may be obtained by the MTC device itself or forwarded from the MTC server via the network. For device-related context information, a MTC device typically knows its own device information. For network-related context information, there are several schemes for a MTC device to obtain such information. In a first scheme, the MTC device is able to obtain part of the network-related information via collection or estimation. For example, MTC device 410 collects historical statistics and estimates network load information based on previous statistics such as RACH collision rate and application traffic characteristics. In a second scheme, the network or application forwards the context information via NAS, S1-AP, or APP level signaling. For example, the network advertises the context information via system information blocks (SIB) (e.g., the context information is forwarded from eNB 420 to MTC device 410, as depicted by step 441). In a third scheme, the context information is forwarded via a paging message on a Paging Channel (PCH) (e.g., a paging message from MTC server 430 to MTC device 410, as depicted by step 442). For example, the paging message includes a state parameter (or uses a special type of paging code or paging ID) to indicate the current load condition (e.g., load level High/Medium/Low). The paging channel may also notify a paged ID or a group of paged node explicit rules for sending RACH (e.g., append barring probability, delay time value, or other related parameters to the paging message). In device-initiated RACH transmission (e.g., push method), MTC device 410 checks the PCH and obtains the context information before starting RACH. In network-initiated RACH transmission (e.g., pull method), MTC device 410 listens to the PCH and obtains the paging message that identifies the paging ID, the RACH access policy, or the context information.

After obtaining the context information, MTC device 410 applies adaptive RACH operation to gain access to the network and to communicate with MTC server 430. There are three options available. In a first option, MTC device 410 adjusts its access probability (step 450) before RACH operation in different levels including APP, NAS, and/or RAN level. In a second option, MTC device 410 adjusts its backoff time (step 460) during RACH operation in different levels including APP, NAS, and/or RAN level. In a third option, MTC device 410 transmits RACH preamble(s) with adjusted RACH resources in RAN level (step 470). For those options, RACH operation is adapted based on the context information including device type, service/app type, levels of loading, and/or historical statistics. Each of the three adaptive RACH options is now described below with additional details.

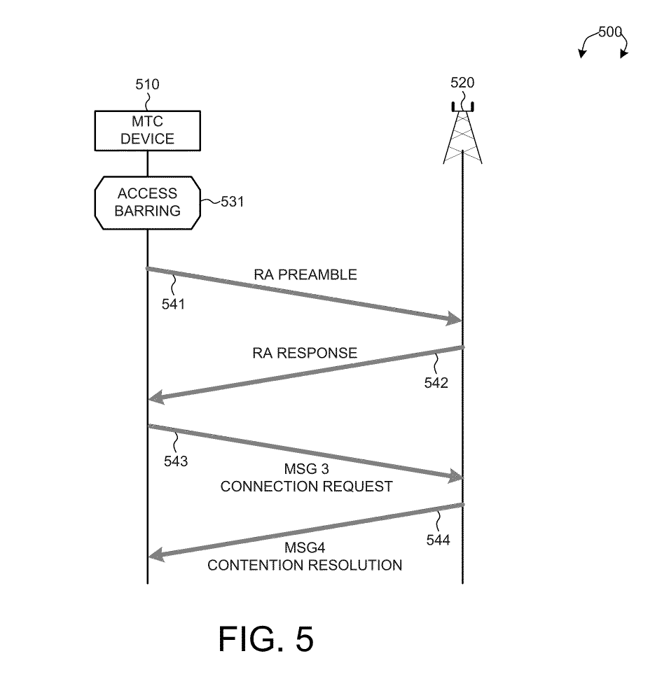

FIG. 5 illustrates a first option of adaptive RACH operation by adjusting access probability in wireless network 500. Wireless network 500 comprises an MTC device 510 and an eNB 520. Before MTC device 510 starts RACH procedure with its serving eNB 520, MTC device 510 adjusts its access probability by performing access barring. As compared to H2H Access Class (AC), M2M Access Class (AC) may apply different access probability, barring parameters, and retry timer parameters. Such procedure may be implemented in application level, NAS level, or RAN level (e.g., RACH access level) access distribution. In application level access distribution, barring is done by prioritize access based on type of services. For example, different access probability is based on QoS requirement and/or delay-tolerant level of different applications. In NAS level access distribution, barring is done by access restriction, e.g., prioritize access based on service type, MTC server, and device ID (e.g. new MTC ID, international mobile equipment identity (IMEI), international mobile subscriber identity (IMSI), etc.). In RAN level access distribution, barring is done by applying different ac-BarringFactor in Access Class Barring mechanism. For example, different barring factors and retry timers are applied for MTC devices. In addition, a new AC class could be defined for M2M, and M2M AC class barring could be implemented in RACH level, core network/application level, or both.

After the completion of access barring in step 531, MTC device 510 then starts RACH procedure with eNB 520. In step 541, MTC device 510 transmits an RA preamble to eNB 520. In step 542, eNB transmits an RA response (RAR) back to MTC device 510. If the RA preamble is successfully decoded, the RAR contains an uplink grant for subsequent uplink transmission for MTC device 510. In step 543, MTC device 510 transmits an RRC connection request (e.g., MSG 3) to eNB 520 via the granted uplink resource. Finally, in step 544, eNB 520 transmits an RRC connection resolution (e.g., MSG 4) back to MTC device 510 to setup an RRC connection with MTC device 510 and complete the RACH procedure. By adjusting access probability using various access distribution techniques implemented in different protocol layers, access probability of a large number of MTC devices is well prioritized and distributed to reduce RACH collision probability.

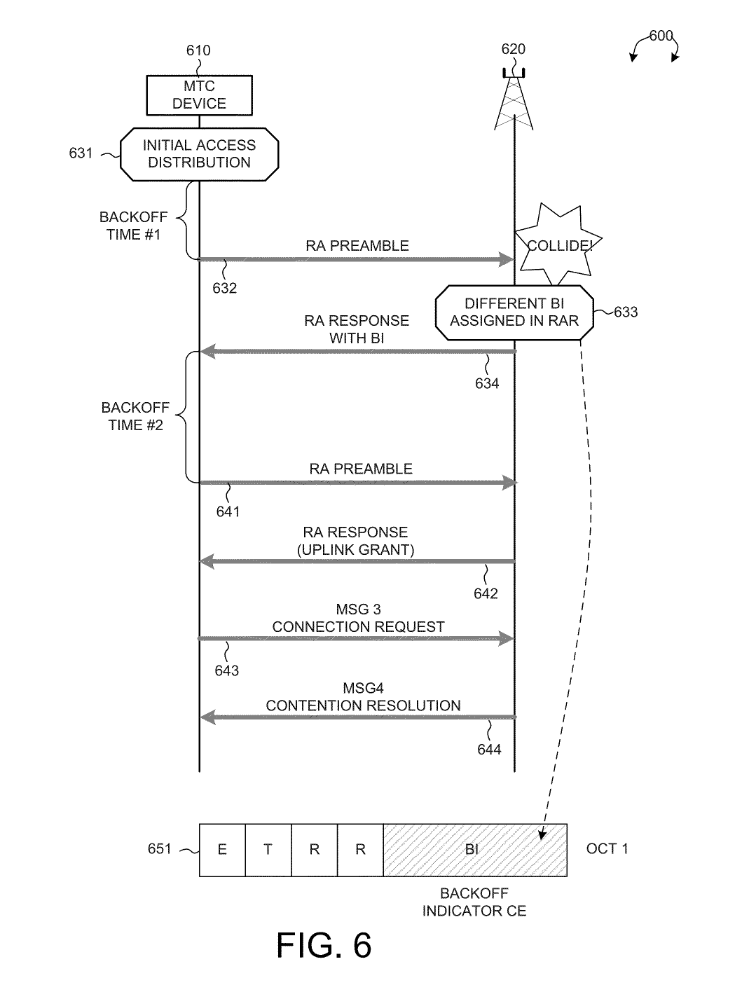

FIG. 6 illustrates a second option of adaptive RACH operation by adjusting backoff time in a wireless network 600. Wireless network comprises an MTC device 610 and an eNB 620. In the second option of adaptive RACH operation, the backoff time for RACH is adaptively adjusted based on context information. The RACH backoff delay may be implemented in application level, core network level (e.g., NAS layer), or RAN level (e.g., RACH access level). In addition, the RACH backoff delay may be applied before transmitting the first RACH preamble as well as after a RACH preamble collision. The initial RACH access distribution before the first RACH prevents high-level RACH contention, and is probably more suitable in application or network level. Once RACH collision is experienced, specific backoff timers can then be applied during RACH procedure for each MTC device.

As illustrated in FIG. 6, MTC device 610 performs initial access distribution in step 631 before the first RACH preamble transmission. More specifically, MTC device 610 applies a first backoff time #1 before transmitting the RACH preamble to eNB 620. The first backoff time may be determined via various ways. In one embodiment, MTC device 610 has a built-in distribution for the value of the first backoff time. For example, each MTC device randomly chooses a value for backoff time #1 from a predefined range. In a second embodiment, the first backoff time is assigned in the application level or network level based on device-related context information. For example, a shorter backoff time may be assigned for applications that are relatively urgent or have lower delay-tolerance. On the other hand, a longer backoff time may be assigned for applications that are more delay-tolerant. Different backoff times may also be assigned based on the service/application type, the MTC server, and the device ID of the MTC device. In a third embodiment, MTC device 610 performs backoff before the first RACH using a new procedure, where the eNB indicates the first backoff time via broadcast through different random access radio network temporary identifiers (RA-RNTI), via reserved bits, or via an RRC message.

After backoff time #1 expires, MTC 610 transmits the RACH preamble to eNB 620 in step 632. Because many MTC devices share the same RACH resource (e.g., RACH resource blocks and RACH preambles), eNB 620 may not able to decode the RACH preamble due to RACH collision. When RACH collision happens, a second backoff time is then applied by MTC 610 before re-transmitting the RACH preamble. Similar to the first backoff time, the second backoff time may be assigned by the application level, the network level, or the RAN level based on context information.

In the example of FIG. 6, eNB 620 determines the second backoff time in step 633 after detecting a RACH collision. For eNB 620, however, it may not know the context information of MTC device 610. In one example, MTC device 610 uses RACH preambles that are dedicated for MTC device type. In another example, MTC device 610 uses RACH resources (e.g., preambles, resource blocks, and subframes) that are dedicated for MTC device type. Based on the dedicated RACH preamble or RACH resources, eNB 620 is able identify the device type of MTC device 610. Once eNB 620 distinguishes different device types, eNB 620 assigns different backoff times through RAR on different RA-RNTI. In one specific embodiment, the second backoff time #2 is assigned using a backoff indicator (BI) contained in the first octet of the E/T/R/R/BI MAC sub-header, as depicted by block 651 in FIG. 6.

After determining the second backoff time in step 633, eNB 620 transmits an RAR with backoff indicator to MTC device 610 in step 634. MTC device applies the second backoff time #2 before re-transmitting the RA preamble in step 641. After successfully decoding the RA preamble, eNB 620 then transmits an RAR with an uplink grant back to MTC device 610 in step 642. In step 643, MTC device 610 transmits an RRC connection request (e.g., MSG 3) to eNB 620 via the granted uplink resource. Finally, in step 644, eNB 620 transmits an RRC connection resolution (e.g., MSG 4) back to MTC device 610 to setup an RRC connection and complete the RACH procedure.

Different backoff times may be applied for different delay-tolerant M2M scenarios. For example, a device may postpone for RACH access until the next discontinuous reception (DRX) active period, if the application has a high tolerance of delay. On the other hand, a device may defer RACH access in the next K time slots, if the application can tolerate for delay in the scale of K time slots. Furthermore, different backoff times may also be applied based on network-related context information and the type of access class. For example, when load is high, a class 1 device (e.g., high priority) defers RACH access within [5, 10] subframes, while a class 2 device (e.g., low priority) defers RACH access within [20, 30] subframes. On the other hand, when load is low, a class 1 device does not defer its RACH access, while a class 2 device defers RACH access within [0, 10] subframes.

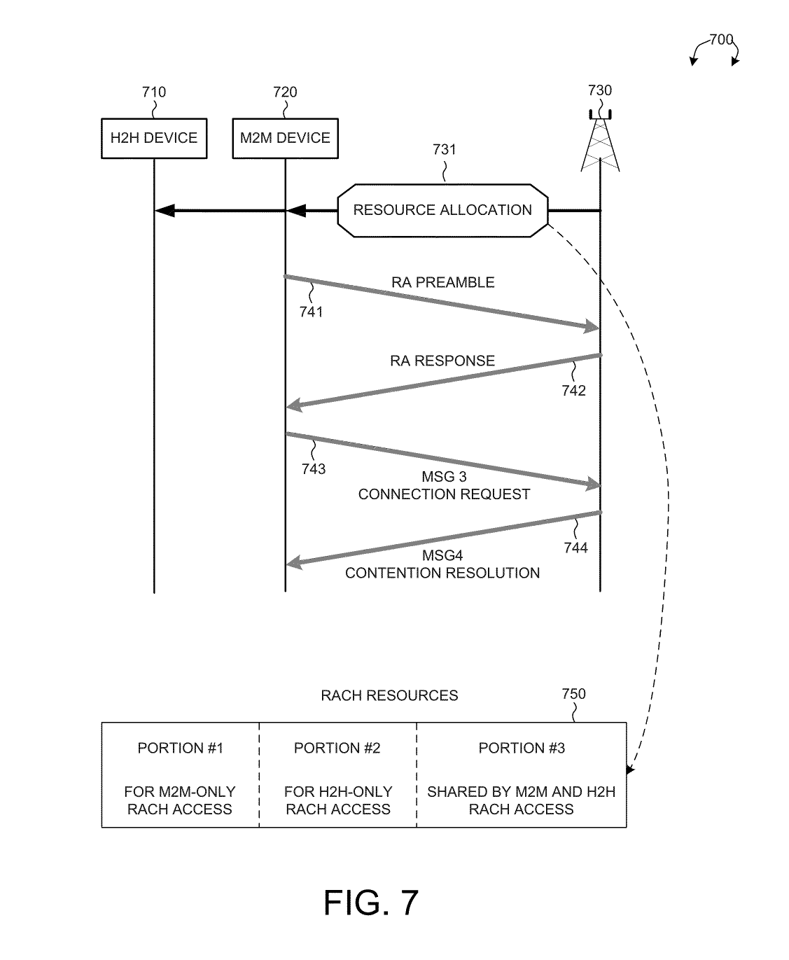

FIG. 7 illustrates a third option of adaptive RACH operation by adjusting RACH resource allocation in wireless network 700. Wireless network 700 comprises an H2H device 710, an M2M device 720, and an eNB 730 serving both H2H device 710 and M2M device 720. In step 731, eNB 730 broadcasts RACH resource allocation to H2H device 710 and M2M device 720. The term RACH resource refers to both RACH radio resources and RACH preambles. In a first embodiment, dedicated RACH radio resource (e.g., radio resource blocks and subframes) is allocated for MTC-only device. For example, new MTC-RACH parameters are defined in SIB2. In another example, to support backward compatibility, new MTC-RACH parameters may be defined in a new SIB (e.g., SIB X). In a second embodiment, dedicated RACH preambles are allocated for MTC-only device.

The network adaptively adjusts RACH resource allocation for resources used by M2M-only devices, H2H-only devices, and by both M2M and H2H devices. As illustrated by block 750 in FIG. 7, for example, the entire RACH resource is separated into three portions. More specifically, the RACH transmission time slots, frequency tones, and preambles are divided into three portions. A first RACH resource portion #1 is allocated for M2M-only RACH access, a second RACH resource portion #2 is allocated for H2H-only RACH access, and a third RACH resource portion #3 is shared by both M2M and H2H RACH access. Based on application requirement and priority access class, devices choose to use either dedicated RACH resource or shared RACH resource. Moreover, the RACH resource allocation is further adjusted based on load information, collision probability, and other context information. For example, the network may allocate all RACH transmission opportunities (time slots, frequency tones, preambles) for H2H access, and allocated a subset of the entire RACH transmission opportunities for M2M-only access. The allocation may be adaptively configured based on M2M traffic load and/or H2H traffic load. The allocation may also be adaptively configured based on collision and retransmission count.

In One example for adaptive resource allocation, an eNB allocates RACH resource that is shared by M2M and H2H access in a first period of time. As long as the number of devices is small, there is no serious collision observed and no need for further optimization. In a second period of time, however, the eNB observes high RACH collision rate. Therefore, the eNB allocates part of the RACH resource dedicated to H2H traffic to guarantee the user experience of normal phone call. Because most M2M traffic is in general more delay-tolerant, the eNB allocates the rest of RACH resource to M2M traffic. If the M2M device number is higher than the allocated RACH resource can support, further enhancement is needed to distribute the M2M traffic, e.g. via RAN/NAS level traffic distribution. The eNB can dynamically adjust the RACH resource, e.g. when there is less phone calls, eNB allocate more RACH resource to M2M traffic.

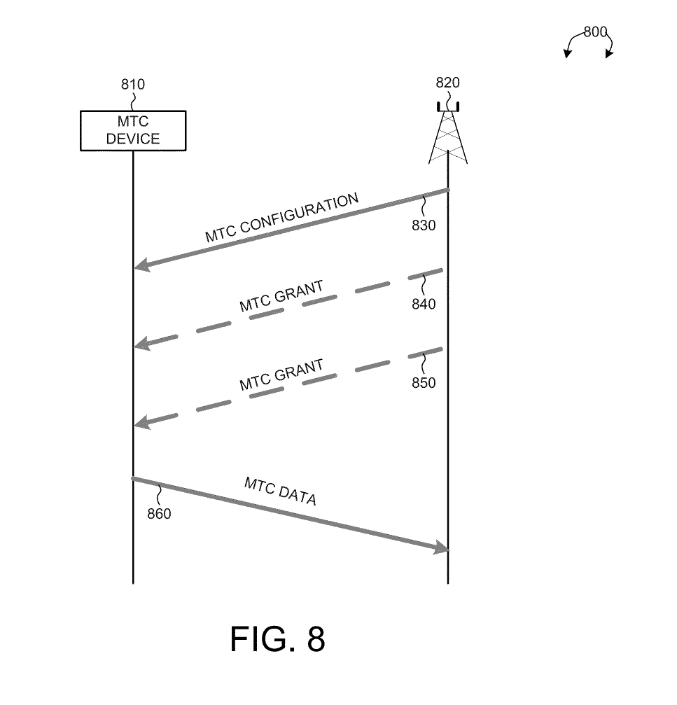

FIG. 8 illustrates a method of RACH-less solution for machine-type communications in wireless network 800. Wireless network 800 comprises an MTC device 810 and an eNB 820. While RACH is normally used for contention-based uplink access for acquiring timing advance (TA) and the first UL grant, the cost of RACH access is high for eNBs. This is particularly true when the number of M2M devices is very large, which is a typical characteristics for many MTC applications. For MTC devices with low mobility or no mobility, however, the TA is always fixed because the MTC devices can rely on the same cell to transmit MTC data. Therefore, it is possible for those MTC devices to use preconfigured UL resource to transmit data because the requirement for MTC is in general fixed over time and across different MTC devices. The UL resource may be shared or dedicated. To reduce RRC signaling overhead, it is possible to transmit the MTC data over the UL resource without RRC establishment. It is also possible for MTC devices under a cell to share a common radio bearer configuration. While RACH needs six RBs, small MTC data transmission only needs one or two RBs. In the example of FIG. 8, eNB 820 transmits MTC configuration to MTC device 810 in step 830, via broadcasting or dedicated transmission. In step 840 and step 850, eNB 820 transmits one or multiple MTC grants. Finally, in step 860, MTC device 810 transmits MTC data using the granted resource. Such RACH-less solution does not require any contention-based access mechanism, and is suitable for many MTC services/applications.

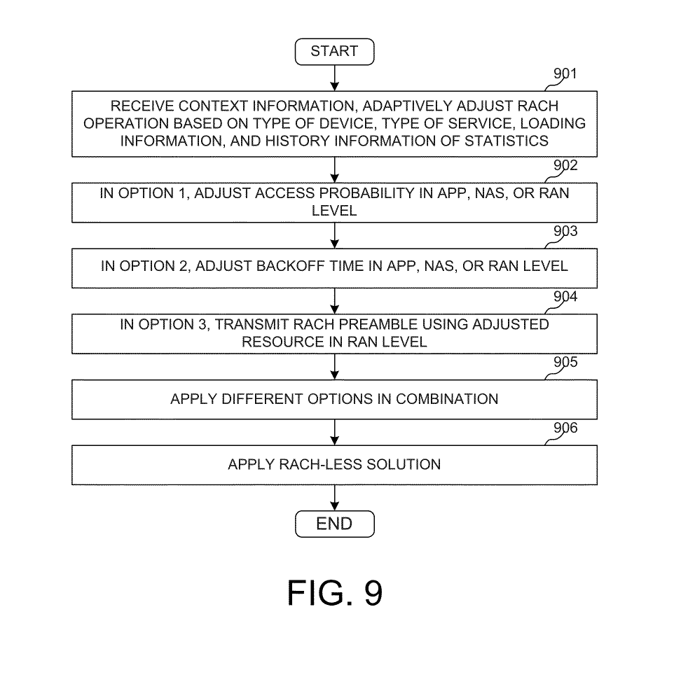

FIG. 9 is a flow chart of a method of adaptive RACH operation for optimized machine-type communication in accordance with one novel aspect. In step 901, an MTC device receives context information from an MTC server. The context information includes device-related information and network-related information. Device related information includes device type and service or application type. Network related information includes network load information and historical statistics information. Based on the context information, the MTC device adjusts various network access and RACH parameters by applying adaptive RACH operation. In a first adaptive RACH operation, the MTC device adjusts (step 902) access probability before RACH in different levels including APP, NAS, and/or RAN level. In a second adaptive RACH operation, the MTC device adjusts (step 903) RACH backoff time during RACH operation in different levels including APP, NAS, and/or RAN level. In a third adaptive RACH operation, the MTC device transmits RA preambles using adjusted RACH resource (step 904) in RAN level. The three options may coexist and be applied in combination (step 905). Finally, in step 906, RACH-less solution is applied for optimized Machine-type communication.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
allocating a first random access channel (RACH) resource by a base station to be used by a plurality of machine-type communications (MTC) devices in a wireless communication network;
allocating a second RACH resource to be used by a plurality of human-to-human (H2H) devices; and
allocating a third RACH resource to be shared by the plurality of M2M devices and the plurality of H2H devices.

2. The method of claim 1, wherein the first, the second, and the third RACH resources are mutually exclusive.

3. The method of claim 1, wherein the first RACH resource is a subset of the second RACH resource.

4. The method of claim 1, wherein RACH resource includes RACH transmission time, RACH transmission frequency, and RACH preamble.

5. The method of claim 1, wherein the first, the second, and the third RACH resources are adaptively allocated based on load information.

6. The method of claim 1, wherein the first, the second, and the third RACH resources are adaptively allocated based on collision probability.

7. The method of claim 1, wherein the first, the second, and the third RACH resources are adaptively allocated based on retransmission count.

8. A base station, comprising:
memory that contains a set of program instructions;
a radio frequency (RF) transceiver that transmits and receives radio signals; and
a processor that executes the set of program instructions in accordance with the radio signals and thereby controls the base station to perform the steps of:
allocating a first random access channel (RACH) resource by a base station to be used by a plurality of machine-type communications (MTC) devices in a wireless communication network;
allocating a second RACH resource to be used by a plurality of human-to-human (H2H) devices; and
allocating a third RACH resource to be shared by the plurality of M2M devices and the plurality of H2H devices.

9. The base station of claim 8, wherein the first, the second, and the third RACH resources are mutually exclusive.

10. The base station of claim 8, wherein the first RACH resource is a subset of the second RACH resource.

11. The base station of claim 8, wherein RACH resource includes RACH transmission time, RACH transmission frequency, and RACH preamble.

12. The base station of claim 8, wherein the first, the second, and the third RACH resources are adaptively allocated based on load information.

13. The base station of claim 8, wherein the first, the second, and the third RACH resources are adaptively allocated based on collision probability.

14. The base station of claim 8, wherein the first, the second, and the third RACH resources are adaptively allocated based on retransmission count.

15. A method, comprising:
receiving machine-type communications (MTC) configuration transmitted from a base station by a MTC device in a wireless communication system;
receiving an MTC uplink grant transmitted from the base station; and
transmitting MTC data in the MTC uplink grant resource region without radio resource control (RRC) connection establishment.

16. The method of claim 15, wherein multiple MTC devices under a cell share a common radio bearer configuration.
